(19) United States
(12) Patent Application Publication
(10) Pub. No.: US 2013/0055325 A1
(43) Pub. Date: Feb. 28, 2013

(54) ONLINE ADVERTISING RELATING TO FEATURE FILM AND TELEVISION DELIVERY OVER THE INTERNET

(71) Applicant: Lucas Wilson, Culver City, CA (US)

(72) Inventor: Lucas Wilson, Culver City, CA (US)

(21) Appl. No.: 13/214,965

(22) Filed: Aug. 22, 2011

(51) Int. Cl. H04N 7/173

(52) U.S. Cl. 725/105

(57) ABSTRACT

A system for providing information to a viewer of a visual content presentation creates a scene database that includes details about many potential scenes planned for a visual content presentation. At least one scene in the scene database is shot then, after shooting scenes and prior to the editing process, the database is updated to reflect actual details used during shooting. The visual content presentation is then edited. After editing the visual content presentation, the database is updated to identify scenes that were actually used in the visual content presentation, and the order in which those scenes appear is specified. A request for details is received from the viewer about at least one aspect of a scene actually used in the visual content presentation, and details are transmitted to the viewer about a requested aspect of the scene actually used in the visual content presentation.

### BACKGROUND

In planning scenes for a pre-recorded content presentation, including but not limited to a feature film or television show, the creators often plan many details of the scene. For example, every object that appears in the scene (furniture, paintings, automobiles, sunglasses, etc.) may be specified in advance. A scene can be planned, for instance, in which a character wears a watch of a particular brand, shoes of a particular brand, specific clothing, drives an automobile of specific make, model and color, uses a specific mobile phone, and so forth. The scene may be taking place on a particular date, in a particular place, and have other very specific background. For example, characters in the scene may be discussing a particular topic.

A common way to plan a scene is to write out the details of the scene with pen and paper, then provide the written plan to others who will implement the scene. There may be many separate plans—lighting, sound, costumes, etc.—and each plan may be in a different format. The typical movie or television episode has thousands of potential scenes, with each scene planned out in detail. When the show is actually produced, all of the scenes may be shot or, more often, the producers choose to shoot only some of the scenes that have been planned, and decide not to shoot others. After production, the scenes are edited into a final content presentation. In the editing process, only some of the scenes that have been shot make it into the final prepared product. Many scenes are omitted from the final product. The order in which scenes appear in the final product may be different than the order in which they were shot.

When the final product is shown, viewers may wish to know more about a particular scene, such as background information on a character, a written version of the dialogue, purchase information about goods or services that they see in the scene, or the like. This relates to the present invention.

### SUMMARY OF THE INVENTION

In accordance with one embodiment of the invention, a method of providing information to a viewer of a visual content presentation includes creating a scene database that includes details about many potential scenes planned for a visual content presentation. One or more scenes in the scene database are shot. After shooting scenes and prior to the editing process, the database is updated to reflect actual details used during shooting. The visual content presentation is then edited.

After editing the visual content presentation, the database is updated to identify scenes that were actually used in the final product, and the order in which those scenes appear is updated. A request is received from a viewer about at least one aspect of a scene actually used in the final product. Details are transmitted to the viewer about a requested aspect of the scene actually used in the visual content presentation.

Particular embodiments may include additional features. The step of creating a scene database may include creating a database containing data about at least one of: objects in a scene, purchase information about objects in a scene, actors in a scene, and story background about a scene. The step of creating a scene database may include importing data from different sources, and the data may be reformatted into a standard format before entry into the database. The sources of data may include, for example only, lighting, production design, costume design, choreography, sound, casting, cinematography, audiography, and/or scripting. The step of recording at least one scene in the scene database may comprise at least one of: shooting a scene for a television program, shooting a scene for a webisode, and shooting a scene for a film.

The step of editing the visual content presentation may include selecting scenes to be actually used in the visual content presentation and putting the scenes in order as they will appear in the visual content presentation. The step of receiving from a viewer a request for details may include receiving a request for details on at least one of: objects in a scene, purchase information about objects in a scene, actors in a scene, and story background about a scene.

The step of transmitting details to the viewer about a requested aspect of the scene may include transmitting details on at least one of: objects in a scene, purchase information about objects in a scene, actors in a scene, and story background about a scene, among other information that the viewer may have requested.

Another embodiment of the present invention relates to a method of providing information to a viewer of a visual content presentation in which a scene database has been created that includes details about many potential scenes planned for a visual content presentation, at least one scene in the scene database then being recorded and, after recording, the database being updated to reflect actual details used during production, the visual content presentation then being edited and the database updated to identify scenes that were actually used in the visual content presentation and specifying the order in which those scenes appear in the visual content presentation. A request is received from a viewer that is watching the visual content presentation for details about at least one aspect of a scene actually used in the visual content presentation. Details from the scene database are transmitted to the viewer about the requested aspect of the scene.

Another embodiment relates to a method of providing information to a viewer of a visual content presentation in which a scene database has been created that includes details about many potential scenes planned for a visual content presentation, scenes in the scene database then being recorded and edited and the database being updated to identify scenes that were actually used in the visual content presentation and specifying the order in which those scenes appear in the visual content presentation. A request is sent across a communications network from a viewer that is watching the visual content presentation for details about at least one aspect of a scene actually used in the visual content presentation. The viewer receives across a communications network in return requested details from the scene database about the requested aspect of the scene. The request may be sent from one of a remote control, a mobile phone, a personal computer, and a touch screen. Making the request may include one or more of freezing a scene on a display, selecting from a menu, and/or clicking or touching on a portion of an image.

The aforementioned features may be combined in a variety of different ways to form different embodiments. It should also be understood that the foregoing Summary is not a complete description of the inventive features and aspects of the invention. Other features and advantages of the present invention will become more apparent from the following Detailed Description, taken in conjunction with the drawings, and from the claims.

### BRIEF DESCRIPTION OF THE DRAWINGS

FIG. 1 illustrates components of an interactive visual content viewing system in which the viewer may request further information concerning a scene of a visual content production;

FIG. 2 illustrates a communications network interconnecting viewers with an information server;

FIG. 3 is a block diagram of steps of an embodiment of a method according to the present invention;

FIG. 4 is a block diagram of steps of an embodiment of a method according to the present invention; and

FIG. 5 is a block diagram of steps of an embodiment of a method according to the present invention.

### DETAILED DESCRIPTION OF THE PREFERRED EMBODIMENTS

The preferred embodiment of the invention relates to a process that allows a person who is watching the film or television show or other visual content to conduct research on a particular scene and/or to purchase items or services of interest relating to the scene. In one embodiment, a person watching the visual content on streaming media (e.g. Netflix, YouTube, Hulu, etc.) can press an on-screen button to find out more information about the scene, such as the identity of items that are shown in the scene, more information about a topic of conversation in the scene, the names of the actors that appear in the scene, details about products shown in the scene, links to purchase items in the scene.

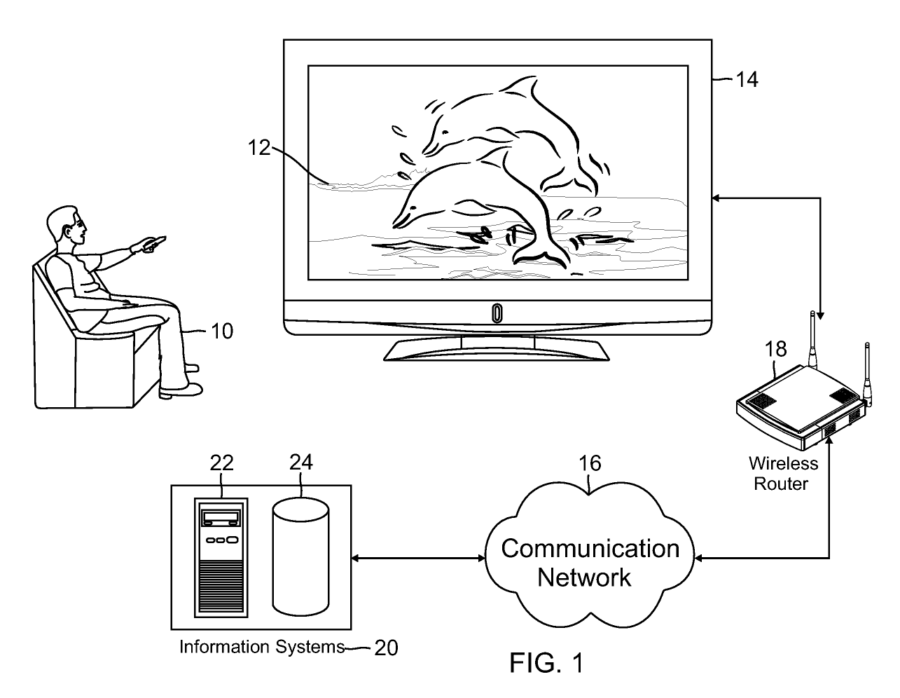

There can be many ways that the viewer can interactively indicate that they want more information about a scene—either while the scene is being shown or by bookmarking the scene for later research. For example, the viewer may wish to stop or “freeze” the scene at a frame of interest. The viewer may then use a hand-held device, for example, to click on an object on the screen and/or pull up an onscreen menu. The viewer may indicate via the hand-held device what further information he or she would like. FIG. 1 illustrates a viewer 10 watching a visual content presentation 12 on screen 14. The screen 14, which may be for example a digital television, is interconnected to the Internet or other network 16 via a wireless router 18 or other device for connecting a device to a network. The screen 14 is interconnected with an information source 20 over the network 16. The information source 20 may include, for example, a server 22 having an information database 24.

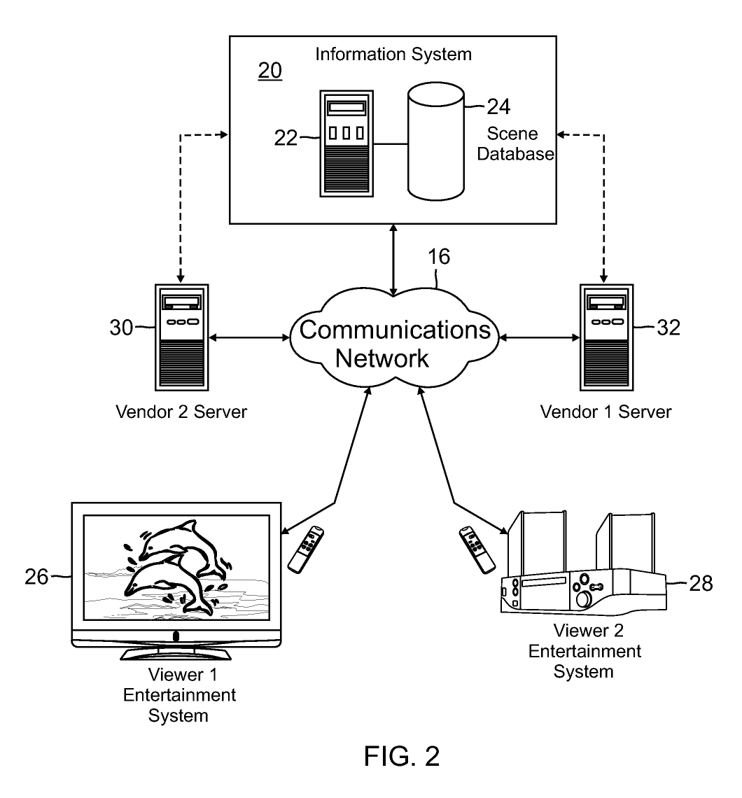

Multiple viewers may have access to the information system 20 simultaneously. In FIG. 2, both a first viewer 26 and a second viewer 28 are interconnected via network 16 to the information system 20. Optionally, the viewers may be interconnected to vendors 30, 32 of services and/or goods that appear in or that are related to the visual content presentation 12, or the information system 20 may instead link to the vendor servers 30, 32.

In one embodiment, a request for information from the viewer is transmitted over the Internet or other network, and the information received is transmitted back over the Internet or other network to the viewer. The television or other screen on which the program is viewed may be connected to the Internet via a direct connection, Wi-Fi, or other method known in the art for permitting interaction between an electronic device and the Internet. Alternatively, communication through the Internet may be accomplished through a handheld device that the user operates to request the desired information, through a unit interconnected with the television, or other means. The present invention is not limited to use with the Internet, however, and alternatively or concurrently the information may be transmitted over a local area network or other means for communicating between, including cellular networks among many others.

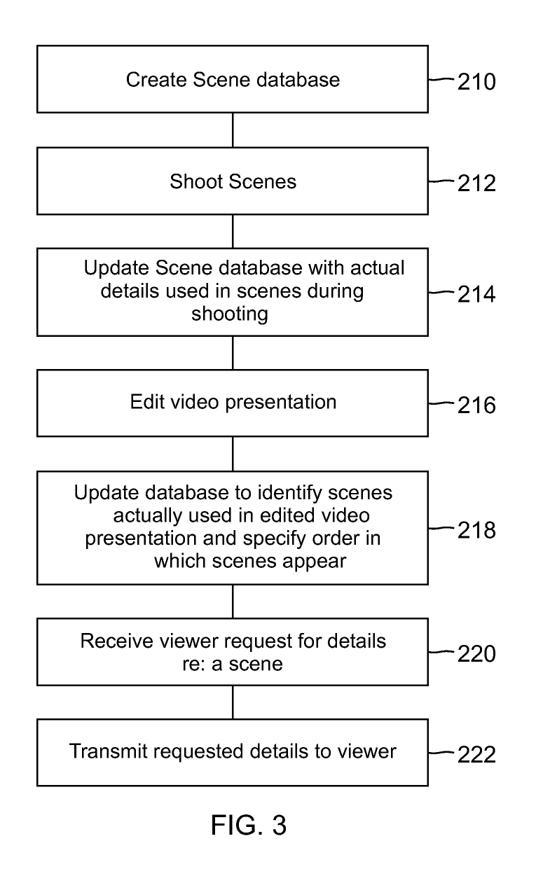

Considering one embodiment of the invention, and referring to FIG. 3, the process includes various steps. Before the visual content presentation—a movie, television show, webisode or the like—is shot, a scene database is created that includes details about many potential scenes planned for the visual content production (Step 210). After shooting of scenes (Step 212) but before the editing process, the database is updated to reflect actual details used during shooting (Step 214). It is noted that in an alternative embodiment, the database is not updated after the scene is shot, especially when a visual content is shot according to the initial plan. After the visual content production is edited (Step 216), the database is updated to identify the scenes that were actually used in the final product and to specify the order in which those scenes appear (Step 218).

Once the visual content presentation is completed, a viewer may request more information about the scene, which can include a wide variety of different requests. For example, the user may wish to know about the time period in which the scene is set, about the actors or people in the scene, information about objects that appear in the scene, may want the spoken dialogue to be displayed on-screen, or may wish to purchase an item, service or the like that appears in the scene or that is mentioned in the scene. As mentioned above, this can be accomplished in a variety of ways, such as the viewer selecting from a menu, clicking on a scene to freeze it and then identifying an object about which more information is desired, entering a query or search term, making a request verbally in conjunction with voice recognition software, or any of a variety of methods used to make requests over a network. Consequently, a request from the viewer is received (Step 220). The request is processed, and the requested information is transmitted to the viewer (Step 222).

One aspect of creating a scene database (Step 210), is that the format of data from various groups and departments involved with a production may differ. Some may format information about a scene in a particular format, while others will use a different format. Consequently, in building the database, it may be desirable to standardize the format of data. That is, when data is presented in a variety of different formats, the step of creating a scene database (Step 210) may include putting data into a standard order or in predetermined fields.

The sources of data will vary depending on the nature of the production. But often, and as example only, some of the sources include information from or regarding: lighting, production design, costume design, choreography, sound, casting, cinematography, audiography, and/or scripting. Consequently, in one embodiment, if the user requests information about a particular costume or clothes that an actor is wearing in a scene, that information is likely to be in the database and can be transmitted upon request to the viewer (Step 222). Similarly, if the viewer requests information about the music soundtrack (e.g. wishes to purchase and download a song), information about the music may be retrieved from the database and/or a screen to purchase the song may be transmitted to the viewer.

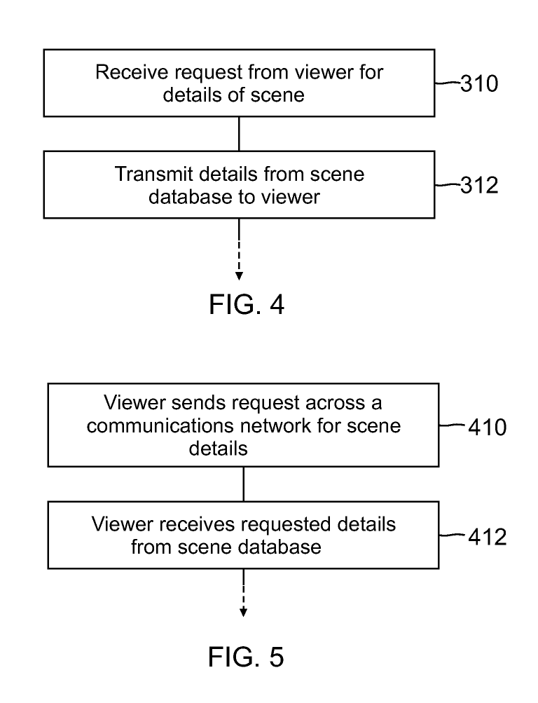

FIG. 4 illustrates Step 310 of the receiving a request from the viewer for details of a scene, as discussed above, which may include a request of any of a wide variety of different types of information that may be stored in the database, or that information from the database may be used to find. In response to the request, the system returns the requested details about the scene and/or other information to the viewer (Step 312). Referring to FIG. 5, from the standpoint of the viewer, in one embodiment of the invention the viewer sends a request across a communications network (e.g. the Internet, a local area network, a cell phone network, etc.) for details about a scene (Step 410). The viewer then receives the requested details from the scene database (Step 412). The requested details may be displayed on the screen on which the viewer is watching the visual content presentation or, alternatively, to a different display such as a remote control, a mobile phone, a PDA, or other display device.

While particular forms of the invention have been illustrated and described, it will be apparent that various modifications can be made without departing from the spirit and scope of the invention. Accordingly, it is not intended that the invention be limited, except as by the appended claims.

What is claimed is:

1. A method of providing information to a viewer of a visual content presentation, the method comprising the steps of:
creating a scene database that includes details about many potential scenes planned for a visual content presentation;
shooting at least one scene in the scene database;
after shooting scenes and prior to the editing process, updating the database to reflect actual details used during shooting;
editing the visual content presentation;
after editing the visual content presentation, updating the database to identify scenes that were actually used in the visual content presentation, and specifying the order in which those scenes appear;
receiving from a viewer a request for details about at least one aspect of a scene actually used in the visual content presentation;
transmitting details to the viewer about a requested aspect of the scene actually used in the visual content presentation.

2. A method as defined in claim 1, wherein the step of creating a scene database includes creating a database containing data about at least one of: objects in a scene, purchase information about objects in a scene, actors in a scene, and story background about a scene.

3. A method as defined in claim 1, wherein the step of creating a scene database includes importing data from different sources.

4. A method as defined in claim 3, wherein data from at least two of the sources is in a different format.

5. A method as defined in claim 4, wherein the step of creating a scene database includes reformatting data from the sources into a standard format.

6. A method as defined in claim 3, wherein the sources of data comprise at least one of:
lighting, production design, costume design, choreography, sound, casting, cinematography, audiography, and scripting.

7. A method as defined in claim 1, wherein the step of recording at least one scene in the scene database comprises at least one of: shooting a scene for a television program, shooting a scene for a webisode, shooting a scene for a live event such as a music concert or a sporting event, and shooting a scene for a film.

8. A method as defined in claim 1, wherein the step of editing the visual content presentation includes selecting scenes to be actually used in the visual content presentation and putting the scenes in order as they will appear in the visual content presentation.

9. A method as defined in claim 1, wherein receiving from a viewer a request for details includes receiving a request for details on at least one of: objects in a scene, purchase information about objects in a scene, actors in a scene, and story background about a scene.

10. A method as defined in claim 1, wherein the step of transmitting details to the viewer about a requested aspect of the scene includes transmitting details on at least one of: objects in a scene, purchase information about objects in a scene, actors in a scene, and story background about a scene.

11. A method of providing information to a viewer of a visual content presentation in which a scene database has been created that includes details about many potential scenes planned for a visual content presentation, at least one scene in the scene database then being shot and, after shooting, the database being updated to reflect actual details used during shooting, the visual content presentation then being edited and the database updated to identify scenes that were actually used in the visual content presentation and specifying the order in which those scenes appear in the visual content presentation, the method comprising the steps of:
receiving from a viewer that is watching the visual content presentation a request for details about at least one aspect of a scene actually used in the visual content presentation; and
transmitting details from the scene database to the viewer about the requested aspect of the scene.

12. A method of providing information to a viewer of a visual content presentation in which a scene database has been created that includes details about many potential scenes planned for a visual content presentation, scenes in the scene database then being shot and edited and the database being updated to identify scenes that were actually used in the visual content presentation and specifying the order in which those scenes appear in the visual content presentation, the method comprising the steps of:
sending a request across a communications network from a viewer that is watching the visual content presentation for details about at least one aspect of a scene actually used in the visual content presentation; and
the viewer receiving across a communications network in return requested details from the scene database about the requested aspect of the scene.

13. A method as defined in claim 12, wherein the step of sending a request across a communications network from a viewer comprises sending a request from one of a remote control, a mobile phone, a personal computer, and a touch screen.

14. A method as defined in claim 12, wherein the step of sending a request from a viewer comprises freezing a scene on a display.

15. A method as defined in claim 12, wherein the step of sending a request from a viewer comprises selecting from a menu.

16. A method as defined in claim 12, wherein the step of sending a request from a viewer comprises clicking or touching on a portion of an image.

17. A method of providing information to a viewer of a visual content presentation, the method comprising the steps of:
creating a scene database that includes details about many potential scenes planned for a visual content presentation;
shooting at least one scene in the scene database;
after shooting scenes and prior to the editing process, updating the database to reflect actual details used during shooting;
editing the visual content presentation;
after editing the visual content presentation, updating the database to identify scenes that were actually used in the visual content presentation, and specifying the order in which those scenes appear;
receiving from a viewer a request for details about at least one aspect of a scene actually used in the visual content presentation; and
transmitting details to the viewer about a requested aspect of the scene actually used in the visual content presentation; wherein:
the step of creating a scene database includes creating a database containing data about at least one of: objects in a scene, purchase information about objects in a scene, actors in a scene, and story background about a scene;
the step of creating a scene database includes importing data from different sources;
the step of recording at least one scene in the scene database comprises at least one of:
shooting a scene for a television program, shooting a scene for a webisode, shooting a scene for a live event such as a music concert or a sporting event, and shooting a scene for a film;
the step of editing the visual content presentation includes selecting scenes to be actually used in the visual content presentation; and
the step of receiving from a viewer a request for details includes receiving a request for details on at least one of: objects in a scene, purchase information about objects in a scene, actors in a scene, and story background about a scene.
